(19) United States
(12) Patent Application Publication
(10) Pub. No.: US 2017/0322963 A1
(43) Pub. Date: Nov. 9, 2017

(54) Apparatus and Method for Creating User Defined Variable Size Tags on Records in RDBMS

(71) Applicant: Huawei Technologies Co., Ltd., Shenzhen (CN)

(72) Inventors: Prasanna Venkatesh Ramamurthi, Bangalore (IN); Kumar Rajeev Rastogi, Bangalore (IN); Dilip Kumar, Shenzhen (CN)

(21) Appl. No.: 15/646,810

(22) Filed: Jul. 11, 2017

Related U.S. Application Data
(63) Continuation of application No. PCT/CN2016/076628, filed on Mar. 17, 2016.

(30) Foreign Application Priority Data
Mar. 28, 2015 (IN) IN1604/CHE/2015

(51) Int. Cl. G06F 17/30

(52) U.S. Cl. CPC G06F 17/30339; G06F 17/30315

(57) ABSTRACT

An apparatus and method for creating user defined variable size tags on records in relational database management systems (RDBMS)are disclosed. When creating a table, one of the columns may be created as a new data-type called a “TAG” data-type. The new data-type called “TAG” is used to store various values for a single column against the single record.

### CROSS-REFERENCE TO RELATED APPLICATIONS

This application is a continuation of International Application No. PCT/CN2016/076628, filed on Mar. 17, 2016, which claims priority to India Patent Application IN1604/CHE/2015, filed on Mar. 28, 2015. The disclosures of the aforementioned applications are hereby incorporated by reference in their entireties.

### TECHNICAL FIELD

The present disclosure, in general, relates to database management systems, and more particularly to an apparatus and method for creating user defined variable size tags on records in relational database management systems (RDBMS).

### BACKGROUND

A database system is generally used to answer queries requesting information from the database stored. A query may be defined as a logical expression over the data and the data relationships expressed in the database, and results in the identification of a subset of the database. In the recent advancements, database systems enable a single query execution to be run in parallel.

There are currently two dominating database technologies, namely the schema bound relational storage and non-schema bound non-relational storage (Not Only Structured Query Language (NoSQL), Key-Value (KV) stores). The NoSQL database provides a mechanism for storage and retrieval of data that is modeled in means other than the tabular relations used in relational databases. The data structures used by NoSQL databases (e.g. KV, graph, or document) differ from those used in relational databases, making some operations faster in NoSQL and some faster in relational databases.

With the advancement in the usage of the Internet, database and computing technology, one of the key needs for RDBMS is the ability to tag records. Typical use cases could be to store tags, timeline information, photos and the like. The historic/timeline information may be very useful for security reason, wherein it has to take some security measurement based on the historic information like prompting for one time password based on the historic usage criteria. Similarly, different qualification/habit for a particular person may be very useful to track the details about a person/employee.

The key challenge in this case is that the number of tags which is different for different records and the max number cannot be determined by the database schema. Hence, the ability to offer such a “tag” mechanism which is operable by structured query language (SQL) is the key problem that needs to be solved.

To achieve the above mentioned need and to solve the above mentioned problems in the prior-art, various solutions were provided.

For example, if multiple data entry required for a single column, then there is a data-type called binary large object/basic large object (BLOB) that stores values in varying length binary string format. To store any kind of information for any purpose, RDBMS allows creating a ‘relation/table’ with set of column fields. Each column fields store some kind of specific value as per that table. Depending on the type of values to be stored, each column should be declared with the corresponding data-type. However in some cases certain features of KV stores is useful for RDBMS technology. RDBMS solve this problem by offering a BLOB technology. The BLOB is a collection of binary data stored as a single entity in a database management system. BLOBs are typically images, audio or other multimedia objects, though sometimes binary executable code is stored as a blob. But the key limitation of this is its lack of querying ability.

Another solution was provided was to have array data-type to store multiple data for a single column.

However, the above mentioned solutions and other existing solutions in the prior-art has at least two major problems mentioned below, that includes but not limited to the key limitation of BLOB data type is its lack of querying ability, and there is no direct possible way to maintain uniqueness of the record if required or removing any part of the record when using the array data type.

### SUMMARY

This summary is provided to introduce concepts related to an apparatus and method for creating user defined variable size tags on records in RDBMS are further described below in the detailed description. This summary is not intended to identify essential features of the claimed subject matter nor is it intended for use in determining or limiting the scope of the claimed subject matter.

### Technical Problem

There is a need to provide the ability to offer an efficient tagging mechanism which is operable by SQL. Further, there is also a need to provide a new data type that is capable of storing any kind of information for any purpose and has flexibility in querying ability. The data type provided must handle all different types of operations performed by any conventional data type that may include but not limited to update, delete, add, and the like.

In one example, the technical problem may be best explained by the example below:

```
CREATE TABLE PERSON
  (ID INT,
  NAME CHAR[100],
  BOOKS_READ INT ARRAY[ ],
    )
```

Now Consider following some of the problem statements
Suppose a user has already inserted a record with values as (100, “xyz”, “A”). Now if again it is required to add new books as “B” for the same person “xyz”, then it is required to update the field BOOKS_READ. Now consider that many books are added to person “xyz” including “A”. If we try to add the same book, then there is no way to avoid that to maintain uniqueness. If some of the books from array data-type column needs to be removed, then there is no way to achieve the same.

In view of the above mentioned problems, there is required a mechanism to support a new data-type, which can perform all kind of operation on variable element for column seamlessly as applicable for any normal data-type including addition of new elements, removal of existing element, avoiding duplicate entries and the like.

### Technical Solution

For solving the above mentioned problems and the other problems, a new concept of a new data-type called “TAG” to store various values for a single column against the single record is disclosed. Further, the a new data-type creates a column with data-type as TAG to store the variable number of elements fields, and allow to hold non-unique or unique record in the TAG column for a single record by specifying the “NON UNIQUE” constraint or omitting the constraints respectively. The data type provided handle or is capable of handling all different types of operations performed by any conventional data type in response to the query received that may include but not limited to update, delete, add, and the like. The present disclosure provides a technical solution and achieves the technical effect by the way of enabling the databases to handle the variable length attributes to achieve faster and efficient access to the data present in the database and further provides a user friendly query syntax to achieve the above technical solution.

The plurality of aspects provides a system and method for parallel optimization of database query using cluster cache. The technical solutions are as follows

In one aspect, a data processing apparatus to create a new data type called a “TAG” or a “tag” dynamically at runtime in response to at least on database query to perform at least one operation on a database is disclosed. The data type is used in a schema bound relational storage and/or a non-schema bound non-relational storage. The data processing apparatus comprises a processors, and a memory coupled to the processor for executing a plurality of instructions present in the memory, when executed, the processor is operable to receive the database query, and configured to create the new data-type called a “TAG”/“tag” configured to generate a column for storing multiple values in a single column against a single record, thereby enabling the querying ability into the database.

In another aspect, a method performed by a data processing apparatus to be used in a schema bound relational storage and/or a non-schema bound non-relational storage, to create a new data type called a “TAG” or a “tag” dynamically at runtime in response to at least on database query to perform at least one operation on a database is disclosed. The method comprises receive the database query, and creating the new data-type called a “TAG”/“tag” configured to generate a column for storing multiple values in a single column against a single record, thereby enabling the querying ability into the database.

In yet another aspect of the present disclosure, when creating a table, the proposed mechanism creates one of the columns as of “TAG” data-type.

In one implementation, by the use of the above mentioned technical solution, the present disclosure provides a mechanism based on the operation requested by user, to internally convert the query to appropriate handler of TAG data-type.

In one implementation, by the use of the above mentioned technical solution, the present disclosure provides a mechanism allow all other kinds of operation along with any kind of query in a seamless way as done for any other data-type.

### BRIEF DESCRIPTION OF THE ACCOMPANYING DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates data processing apparatus to create a new data type called a “TAG” or a “tag” dynamically at runtime in response to at least on database query to perform at least one operation on a database, to be used in a schema bound relational storage and/or a non-schema bound non-relational storage, in accordance with an embodiment of the present subject matter.

FIG. 2 illustrates a method performed by a data processing apparatus to be used in a schema bound relational storage and/or a non-schema bound non-relational storage, to create a new data type called a “TAG” or a “tag” dynamically at runtime in response to at least on database query to perform at least one operation on a database, in accordance with an embodiment of the present subject matter.

FIG. 3 illustrates a data-addition flowchart by the use of new data type, in accordance with an embodiment of the present subject matter.

FIG. 4 illustrates a data-deletion flowchart by the use of new data type, in accordance with an embodiment of the present subject matter.

### DETAILED DESCRIPTION OF THE PRESENT DISCLOSURE

The following clearly describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

The disclosure can be implemented in numerous ways, including as a process, an apparatus, a system, a composition of matter, a computer readable medium such as a computer readable storage medium or a computer network wherein program instructions are sent over optical or electronic communication links. In this specification, these implementations, or any other form that the disclosure may take, may be referred to as techniques. In general, the order of the steps of disclosed processes may be altered within the scope of the disclosure.

A detailed description of one or more embodiments of the disclosure is provided below along with accompanying figures that illustrate the principles of the disclosure. The disclosure is described in connection with such embodiments, but the disclosure is not limited to any embodiment. The scope of the disclosure is limited only by the claims and the disclosure encompasses numerous alternatives, modifications and equivalents. Numerous specific details are set forth in the following description to provide a thorough understanding of the disclosure. These details are provided for the purpose of example and the disclosure may be practiced according to the claims without some or all of these specific details. For the purpose of clarity, technical material that is known in the technical fields related to the disclosure has not been described in detail so that the disclosure is not unnecessarily obscured.

It may be understood by the person skilled in that art that, the runtime data type is assigned to a data object. The data types are defined using type definitions generated by compiling the database query. The instructions to create a runtime data type and the instructions to use the runtime data type may be executed by a virtual machine. The type definitions for the data types are stored in a storage area managed by the virtual machine. The new type definition is stored in a local area for the computer program may be managed by the virtual machine.

Systems and methods for user defined variable size tags on records in an relational DBMS are disclosed.

While aspects are described for creating user defined variable size tags on records in RDBMS may be implemented in any number of different computing systems, environments, and/or configurations, the embodiments are described in the context of the following exemplary systems, devices, and methods.

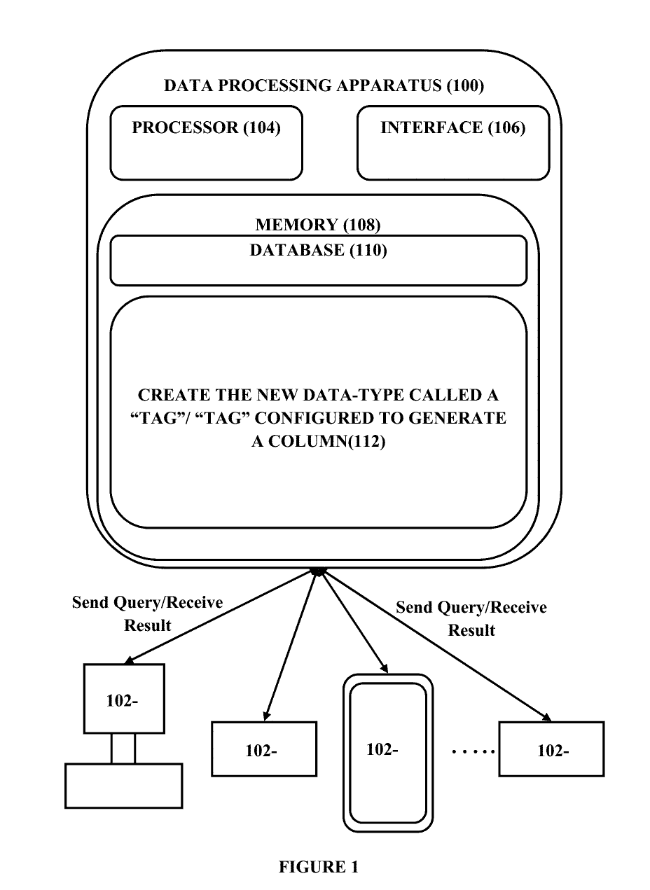

FIG. 1 illustrates a data processing apparatus 100 to create a new data type called a “TAG” or a “tag” dynamically at runtime in response to at least on database query to perform at least one operation on a database is disclosed. The data type is used in a schema bound relational storage and/or a non-schema bound non-relational storage. The data processing apparatus 100 comprises a processors 104, and a memory 108 coupled to the processor 104 for executing a plurality of instructions present in the memory, when executed, the processor 104 is operable to receive the database query, and configured to create 112 the new data-type called a “TAG”/“tag” configured to generate a column for storing multiple values in a single column against a single record, thereby enabling the querying ability into the database.

In one implementation, the data processing apparatus 100 comprises a database 110 and an interface 106.

In one implementation, the data processing apparatus 100 is communicably coupled with the user devices/database client systems 102. Although the present subject matter is explained considering that the data processing apparatus 100 is implemented as a separate computing unit it may be understood that the data processing apparatus 100 may also be implemented on a server, in a variety of computing systems, such as a laptop computer, a desktop computer, a notebook, a workstation, a mainframe computer, a server, a network server, and the like. It will be understood that the data processing apparatus 100 may be accessed by multiple users through one or more user devices/client systems 102-1, 102-2, . . . , 102-N, collectively referred to as user 102 hereinafter, or applications residing on the user devices 102. Examples of the user devices 102 may include, but are not limited to, a portable computer, a personal digital assistant, a handheld device, and a workstation. The user devices 102 are communicatively coupled to the data processing apparatus 100 through a network (not shown).

In one implementation, the network may be a wireless network, a wired network or a combination thereof. The network can be implemented as one of the different types of networks, such as intranet, local area network (LAN), wide area network (WAN), the internet, and the like. The network may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network may include a variety of network devices, including routers, bridges, servers, computing devices, storage devices, and the like.

In one implementation, the at least one processor 104)may be implemented as one or more microprocessors, microcomputers, microcontrollers, digital signal processors, central processing units, state machines, logic circuitries, and/or any devices that manipulate signals based on operational instructions. Among other capabilities, the at least one processor 104 is configured to fetch and execute computer-readable instructions stored in the memory 108.

The interface 106 may include a variety of software and hardware interfaces, for example, a web interface, a graphical user interface, and the like. The interface 106 may allow the client systems/users 102 to interact with a user directly or through the data processing apparatus 100. Further, the interface 106 may enable the data processing apparatus 100 to communicate with other computing devices, such as web servers and external data servers (not shown). The interface 106 can facilitate multiple communications within a wide variety of networks and protocol types, including wired networks, for example, LAN, cable, etc., and wireless networks, such as WLAN, cellular, or satellite. The interface 106 may include one or more ports for connecting a number of devices to one another or to another server.

The memory 108 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 108 may include at least one query compiler configured to prepare an execution plan in a tree structure, with a plurality of plan nodes, for the database query received. It shall be noted that the query compiler is a conventional compiler and the execution plan generation done in the tradition/convention approaches as available in the prior-art.

In one implementation the user 102 interacts with the system 100 by sending/firing a query to the database 110 located at the database server (not shown) or in data processing apparatus 100.

In one implementation, the values are element fields.

In one implementation, the apparatus 100 creates at least one column with a data-type as TAG/tag to store at least one element field against the single record.

In one implementation, the apparatus 100 enables to hold/store non-unique or unique record in the column created for a single record by specifying a “NON UNIQUE” constraint or by omitting the constraints.

In one implementation, the apparatus 100 enables to remove at least one existing element from the record.

In one implementation, the apparatus 100 provides the querying ability enables the operation along with at least one query. In one example, the at least operation is selected from a group of operations comprising insert operation, update record to add an element, update record to add an element, which is already existing in the element field, update record to remove one of existing element, or any combination thereof. In one example, the at least one query is a convention query supported by the database.

In one implementation, based on the operation, the data processing apparatus automatically converts the query to appropriate handler of TAG data-type.

In one implementation, if a new element is to be added to the element field, the data processing apparatus is configured to append the new element at the end of the element field after verifying duplicate entry, wherein, if duplicate entries are found, then the addition of new element is rejected.

In one implementation, if any element is to be removed from the element field, the system is configured to search the element field, and if the element to be removed is found, then the system removes the element, therein after which the data processing apparatus is configured to shift all the elements in the element field after the deleted element to cover the empty space generated.

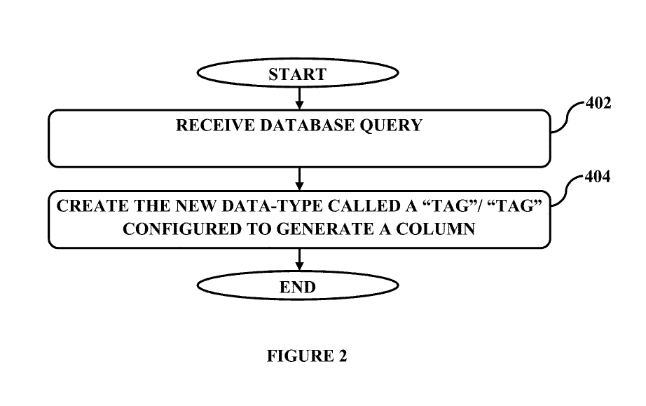

FIG. 2 illustrates a method performed by a data processing apparatus to be used in a schema bound relational storage and/or a non-schema bound non-relational storage, to create a new data type called a “TAG” or a “tag” dynamically at runtime in response to at least on database query to perform at least one operation on a database, in accordance with an embodiment of the present subject matter. The method may be described in the general context of computer executable instructions. Computer executable instructions can include routines, programs, objects, components, data structures, procedures, modules, functions, etc., that perform particular functions or implement particular abstract data types. The method may also be practiced in a distributed computing environment where functions are performed by remote processing devices that are linked through a communications network. In a distributed computing environment, computer executable instructions may be located in both local and remote computer storage media, including memory storage devices.

The order in which the method is described is not intended to be construed as a limitation, and any number of the described method blocks can be combined in any order to implement the method or alternate methods. Additionally, individual blocks may be deleted from the method without departing from the scope of the subject matter described herein. Furthermore, the method can be implemented in any suitable hardware, software, firmware, or combination thereof. However, for ease of explanation, in the embodiments described below, the method may be considered to be implemented in the above described data processing apparatus (100).

At block 402, the database query is received by the data processing apparatus (100).

At block 404, the new data-type called a “TAG”/“tag” configured to generate a column is created.

### Operation on Tag Data-Type

Operation on TAG data-type can be used as below:

Insert operation

INSERT INTO PERSON VALUES (100, ‘xyz’, ‘A’);
Same as existing.
   Update record to add additional entry

UPDATE PERSON SET BOOK_HOLD=+(‘B’) where ID=100;

Update record to add additional entry, which is already existing:

UPDATE PERSON SET BOOK_HOLD=+(‘B’) where ID=100;
this will fail
   In-case if entry is allowed to be duplicate, then while declaring the column of this type along with table creation should mention non-unique constraint e.g.

BOOK_HOLD TAG(NON UNIQUE);

Update record to remove one of existing entry

UPDATE PERSON SET BOOK_HOLD =−(‘B’) where ID-100;

Similarly all other operation can be supported on the invented data-type
Since duplicate record will be there in a single row itself, ID will be same, so removing of any of the duplicate entry will be acceptable. Generally it will remove the first value encountered.
e.g. if data is:
{1,“xyz”, a b c a}
   So if user tries to remove, entry a, then as per the present mechanism it can remove the first one.

### Working Example

In example provided below, implementation of this new data type for maintaining the record on variable length basis is disclosed. Consider the earlier example as per the new data-type

| CREATE TABLE PERSON | |
|---|---|
| ( | |
| ID | INT; |
| NAME | CHAR[100]; |
| BOOKS_HOLD | TAG; |

);

where BOOKS_HOLD may have some other already available data that may include BOOK-A, BOOK-B, . . . , Book-New.

It may be understood by the person skilled in the art that the below mentioned operations are just to provide the mechanism of working of the disclosure and hence the conventional known working of the operations is avoided to create complexity in ones understanding.

### Data Addition

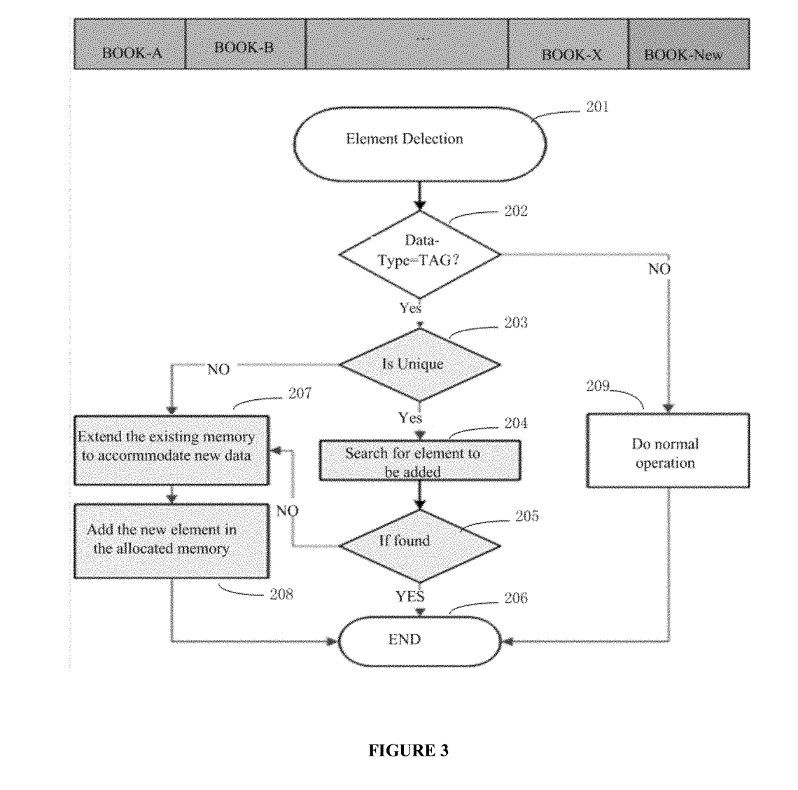

Now if a new element needs to be added to field, then it will be always appended at the end after verifying the duplicate entry if any. If duplicate entries are found, then addition of this element will be rejected. The addition and the flowchart for the addition of the new element is shown in the FIG. 3.

As per the flowchart in FIG. 3, if the element addition query is received by the database (201), it checks if the data-type of the column is TAG or not (202), if the data type is not TAG, it execute the query in convention manner and updated the record by the addition of the new element in the conventional manner (209).

If the data type is TAG, the element is checked to be UNIQUE or not in the record (203). If the element to be added in UNIQUE (204), the mechanism search for element for the addition (205). If the element is not found, it extends the existing memory to accommodate new data/element (207), and adds the new element in the extended allocated memory location (208). If the element to be added is found in the records, it displays the result accordingly as the data addition rejected as already existing (206).

### Data Deletion

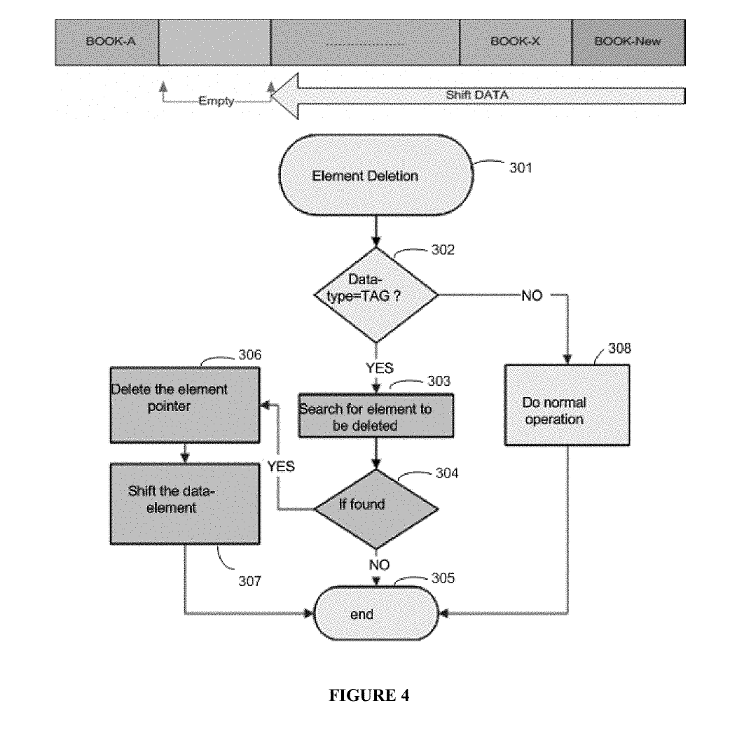

Now if the user is willing to remove one of the existing book (BOOK-B) entry, then same will be searched and will be removed. After which all entry beyond that will be shifted backwards to cover the empty space generated. The deletion of the element is as per the flowchart as shown in FIG. 4.

As per the flowchart in FIG. 4, if the element deletion query is received by the database (301), it checks if the data-type of the column is TAG or not (302), if the data type is not TAG, it execute the query in convention manner and updated the record by the deletion of the element in the conventional manner (308).

If the data type is TAG, the mechanism searches for the element to be deleted in the record (303), if the element found, the pointer to the element is deleted (306) and data element next to the deleted pointer is shifted to the current location (307). If the element not found, the procedure ends (305).

Exemplary embodiments discussed above may provide certain advantages. Though not required to practice aspects of the disclosure, these advantages may include the following: The mechanism disclosed in the present disclosure allows user to work on variable number of elements data-type for a column in same way as any other data-type. The mechanism allows maintaining non-unique value of elements. The user does not have to use any function to do any kind of operation on this kind of data-type. The mechanism will be very helpful for maintaining timeline information for security purpose and doing all short of operation on this. The mechanism will be very helpful to maintain historic information about anyone without duplicating the information. The mechanism create column with data-type as TAG to store the variable number of elements fields. The mechanism allow to hold non-unique or unique record in the TAG column for a single record by specifying the “NON UNIQUE” constraint or omitting the constraints respectively. The mechanism allows user to add or remove cluster information using SQL command to increase the flexibility for the user.

Although implementations for apparatus and method for creating user defined variable size tags on records in RDBMS have been described in language specific to structural features and/or methods, it is to be understood that the appended claims are not necessarily limited to the specific features or methods described. Rather, the specific features and methods are disclosed as examples of implementations of apparatus and method for creating user defined variable size tags on records in RDBMS.

What is claimed is:

1. A data processing apparatus, comprising:
a processor; and
a memory coupled to the processor and configured to store a plurality of instructions that, when executed, causes the processor to:
receive a database query specifying a new data type to perform at least one operation on a database to be used in at least one of a schema bound relational storage or a non-schema bound non-relational storage, wherein the new data type is at least one of a “TAG” or a “tag”; and
specify a database column in a database table during creation of the database table with the new data type wherein the new data type is configured to generate a database column for storing multiple values in the column against a single record which enables a querying ability into the database.

2. The data processing apparatus as claimed in claim 1, wherein values the column are element fields.

3. The data processing apparatus as claimed in claim 1, wherein the memory is further configured to store instructions that, when executed, causes the processor to create at least one column with the new data type to store at least one element field against the single record.

4. The data processing apparatus as claimed in claim 1, wherein the memory is further configured to store instructions that, when executed, causes the processor to store at least one of a non-unique record in the column created for the single record by specifying a “NON UNIQUE” constraint.

5. The data processing apparatus as claimed in claim 1, wherein the memory is further configured to store instructions that, when executed, causes the processor to store a unique record in the column created for the single record by omitting constraints.

6. The data processing apparatus as claimed in claim 1, wherein the memory is further configured to store instructions that, when executed, causes the processor to remove at least one existing element from the record.

7. The data processing apparatus as claimed in claim 1, wherein the querying ability enables the at least one operation along with at least one query, wherein the at least operation is at least one of an insert operation, an update record to add an element, an update record to add an element, which is already existing in the element field, an update record to remove one of existing element, or any combination thereof, and wherein the at least one query is a convention query supported by the database.

8. The data processing apparatus as claimed in claim 6, wherein the memory is further configured to store instructions that, when executed, causes the processor to automatically convert the query to an appropriate handler of TAG data-type based on the at least one operation.

9. The data processing apparatus as claimed in claim 1, wherein the memory is further configured to store instructions that, when executed, causes the processor to append the new element at the end of an element field after verifying a duplicate entry when a new element is to be added to the element field, and wherein the addition of new element is rejected when duplicate entries are found.

10. The data processing apparatus as claimed in claim 1, wherein the memory is further configured to store instructions that, when executed, causes the processor to:
search an element field when any element is to be removed from the element field;
removes the element when the element to be removed is found; and
shift all elements in the element field after the deleted element to cover the empty space generated.

11. A method performed by a data processing apparatus , comprising:
receiving said database query specifying a new data type to perform at least one operation on a database to be used in at least one of a schema bound relational storage or a non-schema bound non-relational storage, and wherein the new data type is at least one of a “TAG” or a “tag”; and
specifying a database column in the database table with the new data type , wherein the new data type is configured to generate a column for storing multiple values against a single record, which enables a querying ability into the database.

12. The method as claimed in claim 11, wherein values in the column are element fields in the column.

13. The method as claimed in claim 11, further comprising storing non-unique records in the column created for a single record by specifying a “NON UNIQUE” constraint.

14. The method as claimed in claim 11, further comprising storing unique records in the column created for a single record by omitting the constraints.

15. The method as claimed in claim 11, further comprising removing at least one existing element from a record.

16. The method as claimed in claim 11, wherein the querying ability enables to perform the at least one operation along with at least one query, wherein the operation is selected from at least one of an insert operation, an update record to add an element, an update record to add an element, which is already existing in the element field, an update record to remove one of existing element, or any combination thereof, and wherein the at least one query is a conventional query supported by the database.

17. The method as claimed in claim 16, further comprising automatically converting the query, based on the operation, to an appropriate handler of TAG data-type.

18. The method as claimed in claim 11, further comprising appending a new element at the end of an element field after verifying a duplicate entry when the new element is to be added to the element field, wherein the addition of new element is rejected if duplicate entries are found.

19. The method as claimed in claim 11, further comprising:
searching an element field when any element is to be removed;
removing the element when the element to be removed is found; and
shifting all elements in the element field after the deleted element to cover the empty space generated.
